(19) United States
(12) Patent Application Publication
(10) Pub. No.: US 2007/0163856 A1
(43) Pub. Date: Jul. 19, 2007

(54) Coaxial friction clutch actuator system

(76) Inventor: Yves J. Kemper, Bloomfield Hills, MI (US)

Correspondence Address: HUSCH & EPPENBERGER, LLC, 190 CARONDELET PLAZA, SUITE 600, ST. LOUIS, MO, 63105-3441, US

(21) Appl. No.: 10/537,327

(22) PCT Filed: Dec. 9, 2003
(86) PCT No.: PCT/US03/38984

§ 371 Date: Sep. 7, 2006

Related U.S. Application Data
(60) Provisional application No. 60/431,853, filed on Dec. 9, 2002.
(60) Provisional application No. 60/436,158, filed on Dec. 23, 2002.
(60) Provisional application No. 60/444,789, filed on Feb. 4, 2003.

(51) Int. Cl. F16D 23/12

(52) U.S. Cl. 192/94; 192/84.6

(57) ABSTRACT

A controlled actuator system for the actuation of a friction clutch comprising a screw drive assembly coaxial with an axis of the clutch composed of a collar and a screw fastened to a gearbox. The controlled actuator system having a friction plate rotatably fastened to control fingers of the clutch and coaxial with the clutch axis and a ball bearing assembly with a first race fastened to the collar and the axis of the bearing assembly being offset from the axis of the clutch. The collar is rotated by a motor. The friction plate and a second race of the bearing assembly are in frictional engagement.

### CROSS-REFERENCE TO RELATED APPLICATIONS

This application claims priority from U.S. Provisional Patent Application No. 60/431,853 filed Dec. 9, 2002, from U.S. Provisional Patent Application No. 60/436,158 filed Dec. 23, 2002 and from U.S. Provisional Patent Application No. 60/444,789 filed Feb. 4, 2003.

### TECHNICAL FIELD OF THE INVENTION

This invention relates to actuator systems, and more specifically to actuator systems to actuate friction clutches.

### Description of the Related Art

Electronically controlled actuator systems are presently used in vehicles to control starting clutches. These actuator systems require powerful motors despite the incorporation of spring means intended to counterbalance the reaction force applied to the release bearing by the control fingers of the clutch. These actuator systems are bulky and need to be mounted on the outside of the clutch housing, and are, therefore, expensive to manufacture.

The present invention is directed to overcome one or more of the problems set forth above.

### SUMMARY OF THE INVENTION

In accordance with the present invention, there is provided an actuator system for the variable control of vehicular starting clutches that are rotatably controlled. The control power is reduced by the action of a servo system which derives its torque from the clutch.

To attain the advantages and in accordance with the present invention, as embodied and broadly described herein, a controlled linear actuator system comprising a screw drive composed of a collar and a screw coaxial with the clutch axis, said screw being fastened to the gearbox, a friction plate rotatably fastened to the control fingers of the clutch and coaxial with said clutch axis, and a ball bearing with a first race fastened to said collar, the axis of said ball bearing being offset from clutch axis, whereas said friction plate and the second race of said ball bearing are in frictional engagement. The screw is rotatably controlled preferably by a motor through a worm gear reduction.

The above aspects are merely illustrative and should not be construed as all-inclusive and construed as limiting the scope of the invention. The aspects and advantages of the present invention will become apparent, as it becomes better understood from the following detailed description when taken in conjunction with the accompanying drawings.

### BRIEF DESCRIPTION OF THE DRAWINGS

Reference is now made more particularly to the drawings which illustrate the best presently known mode of carrying out the invention and wherein similar reference characters indicate the same parts throughout the views.

FIG. 1 is a schematic view of a computer operated vehicular starting clutch system incorporating the actuator according to the invention;

FIG. 2 is a cross-sectional view of an actuator system according to the invention in a plane containing the coaxial axis of rotations of the actuator and of the starting clutch;

FIG. 3 is a cross-sectional view of an alternative embodiment of the actuator system in a plane containing the coaxial axis of rotations of the actuator and of the starting clutch;

FIG. 4 is a cross-sectional view of another alternative embodiment of the actuator system in a plane containing the coaxial axis of rotations of the actuator and of the starting clutch; and

FIG. 5 is a cross-sectional view perpendicular to the plane of FIG. 4 through the line XX′;

FIG. 6 is a cross-sectional view of an alternative embodiment of the actuator system according to the invention in a plane containing both the axis of rotation of the screw drive assembly and of the starting clutch, and illustrated for a starting clutch fully closed; and

FIG. 7 is a graph illustrating the effect of hysteresis on actuator performance.

### DETAILED DESCRIPTION

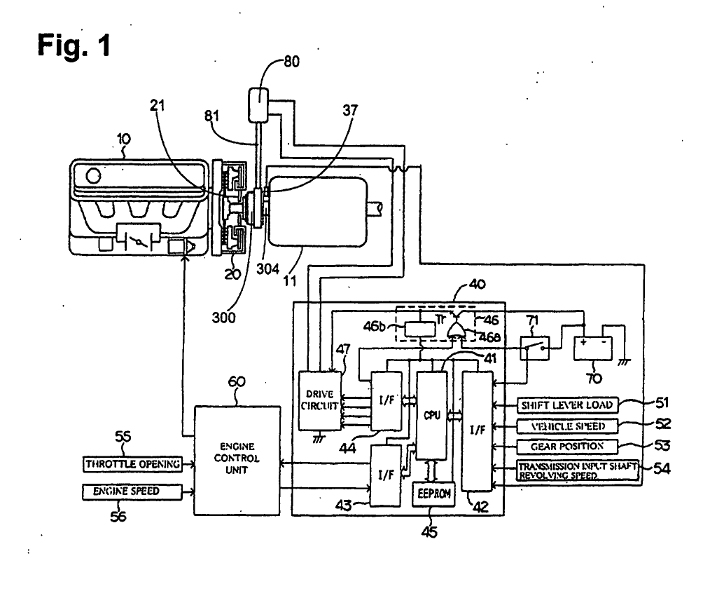

FIG. 1 is a schematic view of a computer operated vehicular starting clutch system. FIG. 1 illustrates schematically an engine 10, a gearbox 11, an engine control unit (ECU) 60, a clutch control circuit 40, a motor 80, an actuator system 300, a battery 70, an ignition switch 71, and a conventional vehicular starting clutch system 20. The clutch 20 includes control fingers 21. The motor 80 drives the actuator system 300 preferably, but not necessarily, through a worm gear reduction system 81. The actuator system 300 is coaxial with a first axis of rotation 301 common to the starting clutch 20 and the engine 10. The actuator system 300 is fastened to the gearbox 11 through its quill 313 and bears axially on the control fingers 21 of the clutch 20. The control system and method of control are preferably, but not necessarily, of the type described in the European Patent EP 1118786 which is hereby incorporated by reference in its entirety.

The clutch 20 is conventional and of the type described in “Manual Transmission Clutch Systems” ISBN 1-56091-923-X which is hereby incorporated by reference in its entirety. The actuator according to the invention can be used for the control of various types of friction clutches, including but not limited to, vehicular starting clutches having an internal wear compensation mechanism. An example of such a starting clutch system is described in the U.S. Pat. No. 5,944,157 which is hereby incorporated by reference in its entirety.

Referring again to FIG. 1, the clutch control circuit 40 includes a microcomputer (CPU) 41, interfaces 42 to 44, an EEPROM 45, a power circuit 46, and a drive circuit 47. The CPU 41 contains a ROM in which a program and a map (a look-up table) are stored, and a RAM.

The interface 42 is connected to the CPU 41 via a bus as well as to: a shift lever load sensor 51 for detecting a load which is generated when the shift lever of transmission is operated (shift lever load); a vehicle speed sensor 52 for detecting a vehicle speed V; a gear position sensor 53 for detecting an actual transmission gear position; a transmission input shaft revolving-speed sensor 54; and a stroke sensor 37 fixedly attached to the actuator 30 and adapted to detect a stroke ST (actual stroke ST) of the rod 31 through detection of the swing angle of the sector gear 35. The interface 42 supplies the CPU 41 with detection signals received from these sensors.

The interface 43 is connected to the CPU 41 via a bus as well as to an engine control unit 60 in a bi-directionally communicating manner. Thus, the CPU 41 of the clutch control circuit 40 can obtain information collected by a throttle opening angle sensor 55 and an engine speed sensor 56 through the engine control unit 60.

The interface 44 is connected to the CPU 41 via a bus as well as to the drive circuit 47 and one input terminal of an OR circuit 46a of the power circuit 46 so as to send an appropriate signal to the drive circuit 47 and the OR circuit 46a according to an instruction from the CPU 41.

The EEPROM 45 is a nonvolatile memory capable of retaining data even when no power is supplied thereto. The EEPROM 45 is connected to the CPU 41 via a bus and adapted to store data received from the CPU 41 and to supply stored data to the CPU 41, while powered.

The power circuit 46 includes: the OR circuit 46a; a power transistor Tr whose base is connected to an output terminal of the OR circuit 46a; and a constant-voltage circuit 46b. The collector of the power transistor Tr is connected to the plus terminal of the battery 70 mounted on the vehicle, whereas the emitter of the power transistor Tr is connected to the constant-voltage circuit 46b and the drive circuit 47. Thus, when the power transistor Tr is turned on, power is supplied to the constant-voltage circuit 46b and the drive circuit 47. The constant-voltage circuit 46b is adapted to convert the battery voltage to a predetermined constant voltage (5 V) and connected to the CPU 41, the interfaces 42 to 44, and the EEPROM 45 so as to supply power thereto. One terminal of the ignition switch 71, which is turned on or off by a driver, is connected to the other input terminal of the OR circuit 46a. The other terminal of the ignition switch 71 is connected to the plus terminal of the battery 70. The terminal of the ignition switch 71 connected to the OR circuit 46a is also connected to the interface 42, so that the CPU 41 can detect the on/off state of the ignition switch 71.

The drive circuit 47 contains four switching elements (not shown) which go on or off in response to an instruction signal received via the interface 44. These switching elements constitute a known bridge circuit and are selectively turned on with their ON periods being controlled. Thus, the drive circuit 47 supplies power to the electric motor 80 such that a current of a certain intensity flows to the electric motor 80 in a predetermined direction or in a direction opposite the predetermined direction.

The engine control unit 60 is mainly composed of an unillustrated microcomputer and adapted to control, for example, the amount of fuel to be injected and ignition timing. As mentioned previously, the engine control unit 60 is connected to the throttle opening angle sensor 55 for detecting a throttle opening angle TA of the engine 10 and the engine speed sensor 56 for detecting a rotational speed NE of the engine 10 so as to receive signals from the sensors 55 and 56 and so as to process the received signals.

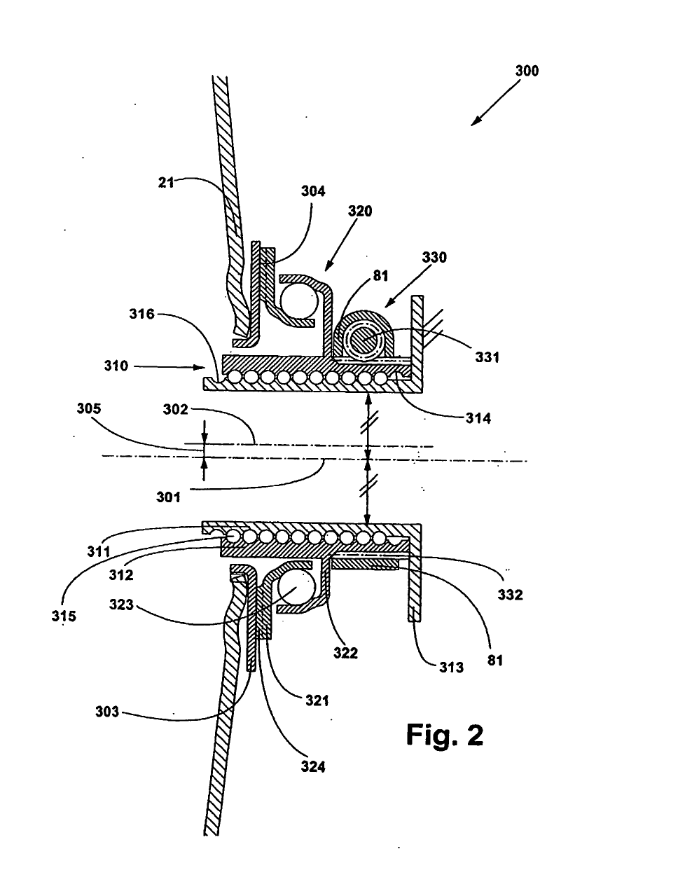

FIG. 2 is a cross-sectional view of the actuator system 300 in a plane containing the coaxial first axis of rotation 301 of said actuator and of the clutch 20.

The actuator system 300 is composed of a friction plate 303, a screw drive assembly 310, a ball bearing assembly 320, and a worm gear reduction assembly 330, which are all coaxial with the first axis 301 of the clutch 20. The bearing assembly 320 is not coaxial with the first axis 301 of the clutch 20. The bearing assembly 320 is offset from the first axis 301 by a distance 305.

The screw drive assembly 310 is composed of a collar 312 and a screw 311 having a pitch different than zero, and preferably, but not necessarily, separated by a series of balls 315 rolling in spiral grooves 314 and 316. The flange 313 of the screw 311 is fastened by adequate means to the gearbox 11.

The friction plate 303 is rotated by, and bears against, the control fingers 21 of the clutch 20.

A first race 322 of the bearing assembly 320 is fastened by adequate means to the screw drive assembly 310. A second race 321 of said bearing assembly 320 is in frictional engagement with the frictional plate 303. In the depicted embodiment, the bearing assembly 320 includes balls 323 between the first race 322 and the 30 second race 321.

The worm gear reduction assembly 330 is composed of a worm 331 and a gear 332, fastened to, or machined on, the outside periphery of the collar 312. The housing 81 of the worm gear reduction assembly 330 surrounds the collar 312. The worm 331 is rotatably controlled by the motor 80.

The friction plate 303 rotates with the control fingers 21 of the clutch 20 and is in frictional engagement with the second race 321. Because a second axis 302 of the second race 321 is offset by the distance 305 from the first axis 301, a tangential friction force is generated on the center of the bearing assembly 320, and since the second axis of rotation of the bearing assembly 320 is offset by the distance 305 from the first axis of the collar 312, said tangential force generates a first torque on the collar 312 with a radius of application equal to the distance 305. The first torque is proportional to the reaction force of the control fingers 21. The first torque tends to rotationally bias the screw drive assembly 313 in a first direction.

The control fingers 21 apply an axial force to the collar 312 through the friction surface 304 and the bearing assembly 320, and because of the pitch of the screw drive 310 said axial force generates a second torque which tends to rotate the collar 312. In other words, the second torque tends to rotationally bias the screw drive assembly 313 in a second direction opposite said first direction. The second torque is also proportional to the reaction force of the control fingers 21.

Hence, the friction ring is in frictional contact with the friction plate (at all times) thereby generating a tangential friction force. That tangential friction force is exerted at an offset. Thus, the force times the distance produces a first torque. This first torque tends to rotate the screw assembly in a first direction. Additionally, because the friction ring is in contact with the friction plate, the control fingers exert an axial force (due to spring force) on the bearing assembly/screw assembly. The screw assembly has a thread pitch. Therefore, the axial force from the control fingers tends to rotate the screw along the pitch, thus generating a second torque opposite to the first.

The pitch of the screw drive 310 and the offset distance 305 are preferably designed such that the first torque and the second torque are balanced regardless of the level of the reaction force of the control fingers 21. This is possible because they are both proportional to the reaction force of the control fingers 21. In this case the amount of torque applied by the worm 331 during the actuation of the clutch 20 is equal to zero.

Alternatively, the second race 321 of the bearing assembly 320 has a friction ring 324 of a dry bearing material, graphite or any adequate dry friction material, fastened to its surface by adequate means. Preferably, the friction ring 324 is a polytetrafluoroethylene (PTFE)-based metal-polymer material bearing, such as a DU™ bearing by Glacier Garlock Bearings, Inc. of Thorofare, N.J.

The actuator system 300 functions as follows. Under the control of the clutch control circuit 40, the motor 80 rotates the worm 331, which in turn rotates the collar 312. When the collar 312 rotates it also moves axially because of the pitch of the screw drive 310, carrying with it the bearing assembly 320 and finally axially moving the control fingers 21.

Alternatively, the second race 321 of the bearing assembly 320 has a friction ring 324 of DU, graphite or any adequate dry friction material, fastened to its surface by adequate means.

Alternatively, the friction ring 324 is fastened to the friction plate 303, and is in frictional engagement with the race 321.

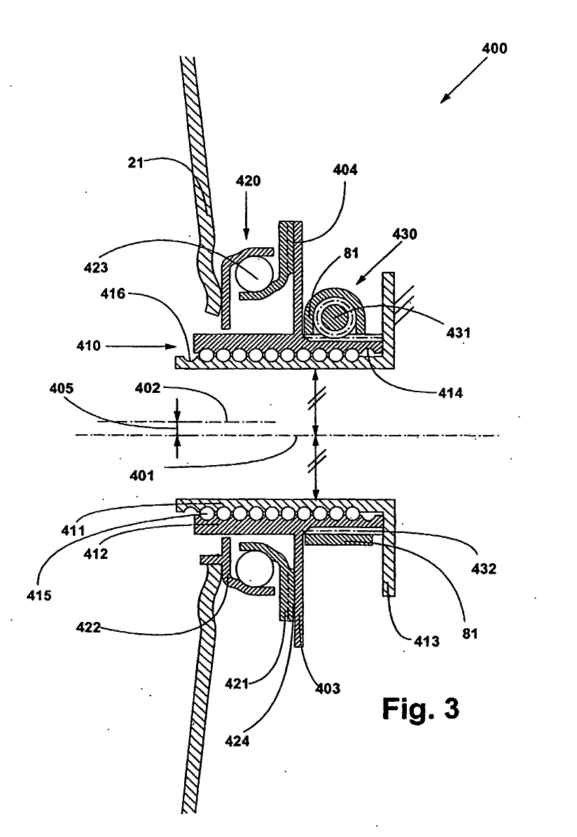

FIG. 3 is a cross-sectional view of an alternate embodiment 400 of the actuator system 300 of FIG. 2. The embodiments depicted in FIGS. 2 and 3 are essentially the same, but for the bearing assembly 320 and the friction plate 303 which trade places. The actuator system 400 is illustrated in a plane containing the coaxial third axis of rotation 401 of said actuator and of the clutch 20.

The actuator system 400 is composed of a friction plate 403, a screw drive assembly 410, a ball bearing assembly 420, and a worm gear reduction assembly 430, which are, again, all coaxial with the third axis 401 of the clutch 20 except for the bearing assembly which is offset by a distance 405.

The screw drive assembly 410 is composed of a collar 412 and a screw 411 having a pitch different than zero, and preferably, but not necessarily, separated by a series of balls 415 rolling in spiral grooves 414 and 416. The flange 413 of the screw 411 is fastened by adequate means to the gearbox 11.

The friction plate 403 is fastened by adequate means to the collar 412 of the screw drive 410.

The first race 422 of the bearing assembly 420 is rotated by, and bears against, the control fingers 21 of said clutch. The second race 421 of the bearing assembly 420 is in frictional engagement with the friction plate 403.

The worm gear reduction assembly 430 is composed of a worm 431 and a gear 432, fastened to, or machined on, the outside periphery of the collar 412. The housing 81 of the worm gear reduction 430 surrounds the collar 412. The worm 431 is rotatably controlled by the motor 80.

The first race 422 rotates with the control fingers 21 of the clutch 20 and the second race 421 is in frictional engagement with the friction plate 403. Because a fourth axis 402 of the second race 421 is offset by the distance 405 from the third axis 401, a tangential friction force offset by the distance 405 is generated on the friction surface 404, and said tangential force generates a first torque on the collar 412 with a radius of application equal to the distance 405. The first torque is proportional to the reaction force of the control fingers 21.

The control fingers 21 apply an axial force to the collar 412 through the friction surface 404 and the bearing assembly 420, and because of the pitch of the screw drive 410 said axial force generates a second torque which tends to rotate the collar 412. The second torque is also proportional to the reaction force of the control fingers 21.

The pitch of the screw drive 410 and the offset distance 405 are preferably designed such that the first torque and the second torque are balanced whatever the level of the reaction force of the control fingers 21. This is possible because they are both proportional to the reaction force of the control fingers 21. In this case the amount of torque applied by the worm 431 during the actuation of the clutch 20 is equal to zero.

Alternatively, the second race 421 of the bearing assembly 420 has a friction ring 424 of DU, graphite or any adequate dry friction material, fastened to its surface by adequate means.

Alternatively, the friction ring 424 is fastened to the friction plate 403, and is in frictional engagement with the second race 421.

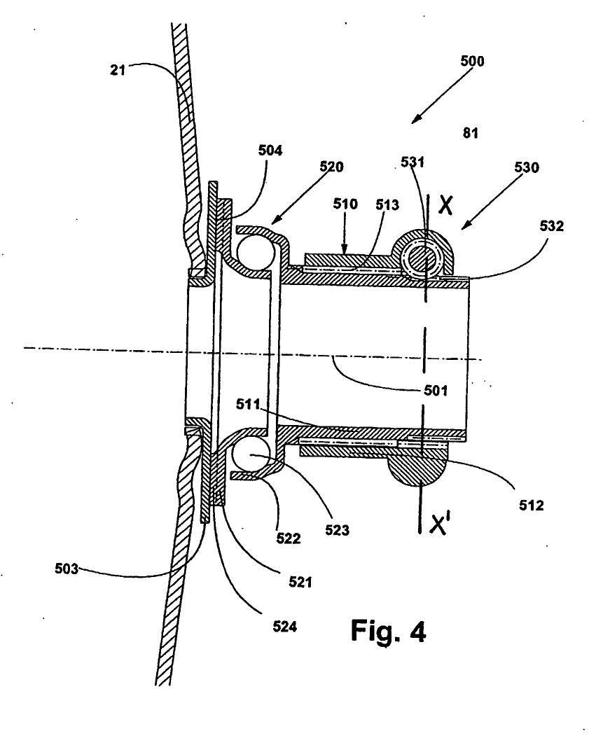

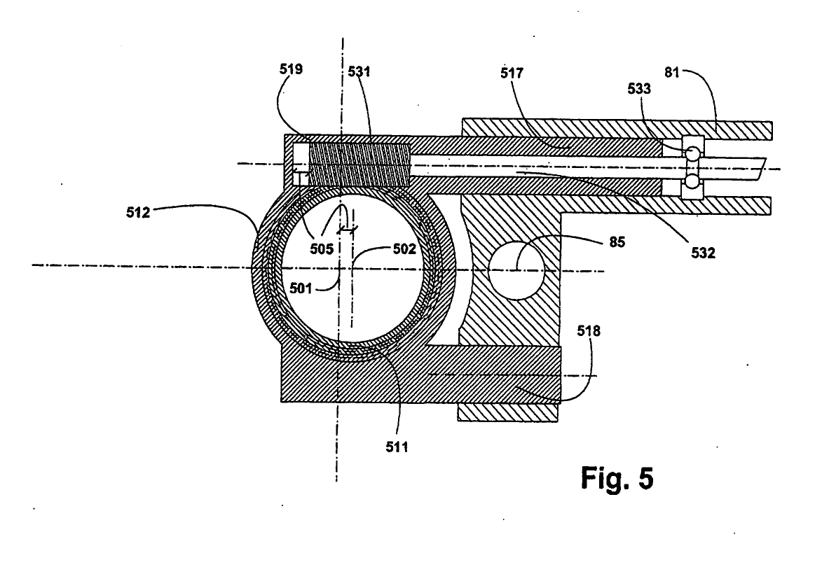

FIG. 4 is a cross-sectional view of an alternate embodiment 500 of the actuator systems 300 of FIG. 2, and FIG. 5 is a cross-sectional view perpendicular to the plane of FIG. 4 through the line XX′.

The embodiments depicted in FIGS. 2 and 4 are essentially the same, but for provisions to allow a variation of the offset distance 505 whereas the offset distance 305 is constant. The actuator 500 is illustrated in a plane containing a fifth axis of rotation 501 of the actuator and of the clutch 20.

A screw drive assembly 510 is composed of a collar 512 and a screw 511 having a pitch different than zero. A friction plate 503 is rotated by, and bears against, the control fingers 21 of the clutch assembly 20.

A first race 522 of a ball bearing assembly 520 is fastened by adequate means to the screw 51 1. A second race 521 of the bearing assembly 520 is in frictional engagement with the friction plate 503.

A worm gear reduction assembly 530 is composed of a worm 531 and a gear 532. The gear 532 is fastened to, or machined on, the outside periphery of the screw 511. The worm 531 is rotatably controlled by the motor 80.

A housing 519 of the worm 531 is preferably integral with the collar 512, and has two extensions, respectively 517 and 518, which can slide by the distance 505 in a support 81 fastened to the gearbox 11 by adequate means. A shaft 532 that rotatably drives the worm 531 is located axially by a bearing 533. The housing 519 moves axially such that the distance 505 varies between a maximum and a minimum.

When the offset distance 505 is different from zero, as explained in connection with the embodiment of FIG. 2, a tangential force is generated in the center of the bearing assembly 520 which has the effect to apply a first torque to the screw 512. Said torque is proportional to the reaction force of the control fingers 21 and to the coefficient of friction of a surface 504.

The friction plate 503 rotates with the control fingers 21 of the clutch 20 and is in frictional engagement with the second race 521. The control fingers 21 apply an axial force to the collar 512 through the friction surface 504 and the bearing assembly 520, and because of the pitch of the screw drive 510, said axial force generates a second torque which tends to rotate the collar 512. The second torque is also proportional to the reaction force of the control fingers 21.

To disengage the clutch assembly 20 the screw 511 and the worm 531 are rotated in a positive rotational direction, and to engage the clutch 20, in a negative rotational direction.

There is a friction between the threads 513 of the screw drive assembly 510, and a positive friction torque opposes the rotation of the screw in the positive direction, and a negative friction torque opposes the rotation of the screw in the negative direction. The positive and negative friction torques are proportional to the reaction force of the control fingers 21.

The pitch of the screw drive 510 and the maximum offset distance 505 are preferably, but not necessarily, designed such that when the screw is rotated in the positive direction, the sum of the first torque, the second torque and the positive friction torque is equal to zero regardless of the level of the reaction force of the control fingers 21. This is possible because all said torques are proportional to the reaction force of the control fingers 21. In this case the amount of torque which has to be applied by the worm 531 to disengage the clutch 20 is equal to zero.

Starting with a clutch 20 engaged and the offset distance 505 of zero, the actuator system 500 functions as follows. When the worm 531 is rotated by the motor in the positive direction under the control of the ECU 40, and since the offset distance 505 is equal to zero, the sum of the first, the second and the positive friction torques are relatively high and opposes said positive rotation. As a result, because the worm 531 is held axially by a bearing 533, the worm 531 instead moves the housing 519 to the right in the FIG. 5 reducing the distance 505, and in the process, reducing the sum of the torques applied to the screw 511 since the friction torque generated on the surface 504 increases with the offset. When the offset reaches its maximum value, the worm 531 is able to start the rotation of the screw 511 in the positive direction to disengage the clutch 20 because the sum of the torques applied to the screw 511 is zero.

When the torque capacity of the clutch 20 is reduced to the desired level by rotating the screw 511 in the positive direction, the screw 511 is rotated by the motor 80 under the control of the clutch control circuit 40 in the negative direction. But since the screw opposes a rotation in this negative direction when the offset is at the maximum position because the torques applied to the screw 511 are high in that direction, the screw does not move and instead the housing 519 moves to the left in FIG. 5 until the offset reaches its minimum. When the offset 505 reaches its minimum, the first torque is down to zero because the offset is zero, and the second torque is higher or equal to the negative friction torque, and therefore the screw 511 tends to rotate in the negative direction. The screw 511 cannot rotate by itself because the worm 531 is irreversible, and therefore the screw 511 rotates only when the motor 80 is rotated under the control of the clutch control circuit 40 in the negative direction. It should be noted here that when the offset 505 is zero the power to rotate the screw 511 in the negative direction is very low since the net resulting torque applied to the screw 511 tends to rotate the screw 511 in that the second direction anyway.

The method of control is as follows. The amount of offset 505 is kept as a rule at its minimum position, in which position the screw is locked by the worm 531, and therefore the torque capacity of the clutch 20 remains at whatever level it has reached previously. If the torque capacity of the clutch 20 has to be raised, the worm 531 is rotated in the negative direction in which case the offset remains at zero. If the torque capacity of the clutch 20 has to be lowered, the worm 531 is rotated in the positive direction, and initially the offset is raised to its maximum, and thereafter the screw 511 is rotated in the positive direction, and when the torque capacity of the clutch 20 reaches the desirable level, under the control of the clutch control circuit 40 the offset is brought to zero by rotating the worm 531 by a set number of turns in the negative direction. This method has the advantage to reduce the amount of heat generated in the friction surface 504 to a minimum, because the heat dissipation occurs only during the length of time the amount of offset varies.

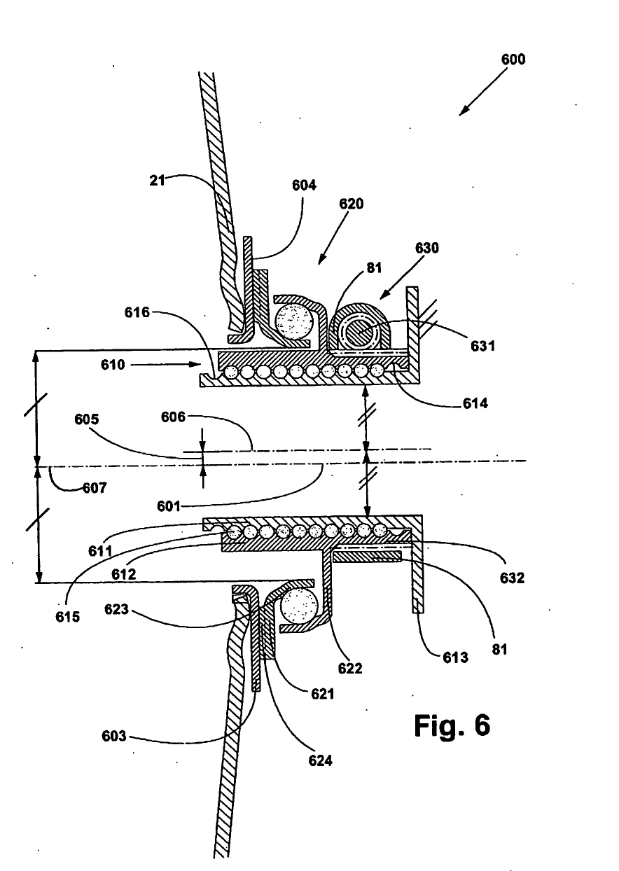

FIG. 6 is a cross-sectional view of the actuator 600 system, an alternate embodiment of the actuator 300 system illustrated in FIG. 2, illustrated in a plane containing a seventh axis of rotation 606 of the screw drive assembly 610 and an eighth axis 601 of the starting clutch 20, and illustrated with the starting clutch 20 fully closed. The only difference between the embodiments depicted in FIGS. 2 and 6 resides in the allocation of the offset. In the embodiment depicted in FIG. 6, the offset is split between two components. First, the seventh axis 606 of the screw drive assembly 610 is offset from the eighth axis 601 of rotation of the clutch 20 by a distance 605 equal to Doffset/2. Second, a ninth axis 607 of a bearing assembly 620 is offset by the same distance 605 relative to the screw drive assembly 610, which has the effect that the distance between the ninth axis 607 of the bearing assembly 620 and the eighth axis 601 of rotation of the clutch assembly 20 varies when a collar 612 is rotated over its range. In other words, the two components provide the total offset as the collar 612 is rotated over its range. In FIG. 6 the actuator system 600 is illustrated for a clutch 20 fully closed and therefore the ninth axis 607 and the eighth 601 are coaxial.

The system is designed preferably, but not necessarily, such that, when the collar is at one end of its rotational range (0 degrees) the clutch is fully closed, and when at the other end of its range (360 degrees), the clutch is fully closed.

When the clutch 20 is electronically controlled it is advantageous to reduce the rated power of the motor 80 as much as practical. It is possible to reduce the rated power to zero by machining the screw drive 610 with a continuously variable pitch according to the following equation, where β is the angle of rotation of the collar 612, μ is the coefficient of friction of the ring of graphite 624, and Doffset is the offset distance 605:
pitch=Sin (β/2)×2 Doffset×2π×μ

In the screw drive assembly 610 with a continuously variable pitch, the number of balls is reduced to two, and the screw drive assembly 610 is multithreaded (two or three threads), each with a single ball 615. This type of screw drive assembly is known in the art as a “ball ramp.”

The actuator system 600 functions as follows. Under the control of the clutch control circuit 40, the motor 80 rotates a worm 631, which in turn rotates the collar 612. When the offset 605 is sinusoidal, and is equal to zero (as illustrated in FIG. 6), the offset changes from zero to a maximum equal to twice the distance 605 and back to zero again. The power supplied by the motor 80 is essentially the power necessary to overcome the parasitic friction losses and any discrepancies in the dimensions and in the coefficient of friction μ of the ring of graphite 624.

When the pitch of the screw drive assembly 610 is constant, the control power is not anymore equal to zero across the range of rotation of the collar 612, but is a fraction of what it would be without the friction on the ring of graphite 624.

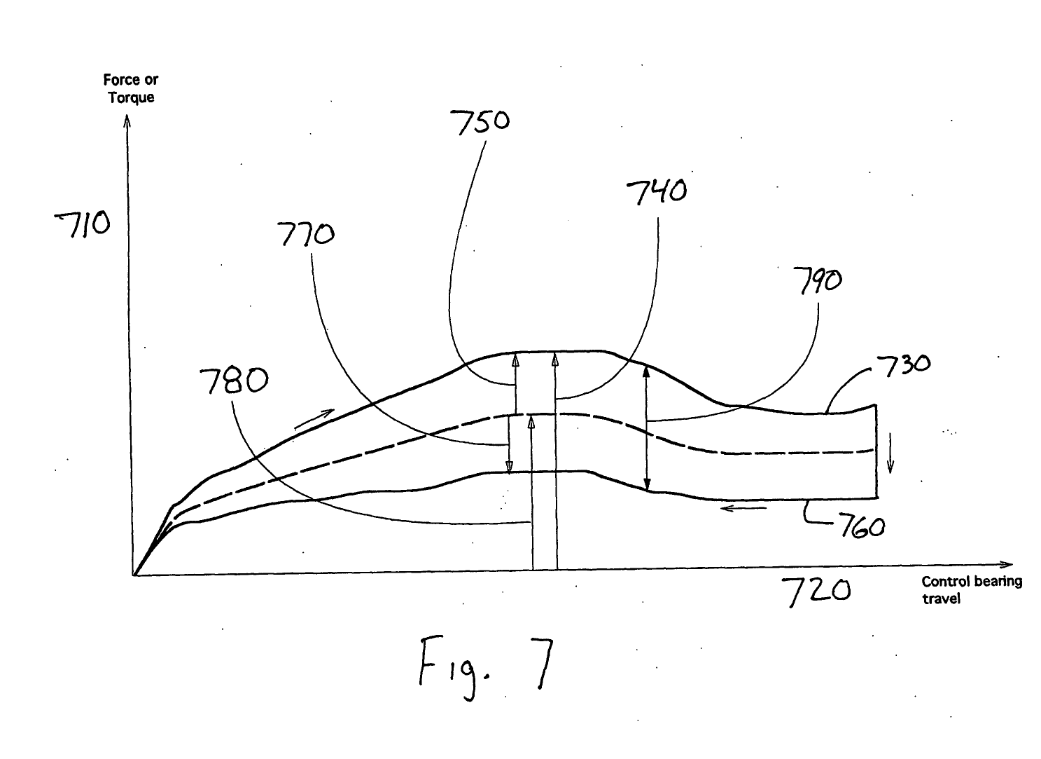

FIG. 7 illustrates the effect of hysteresis on the level of actuator performance. Force or torque 710 is generally noted on the left-hand side of the graph. Control bearing travel 720 is generally noted along the bottom of the graph. A first line 730 indicates the force or torque required to open the clutch. First arrow 740 indicates the torque or force required to open the clutch without assistance from the friction ring, for example a DU™ ring. Second arrow 750 indicates the torque required to open the clutch with the assistance of the friction ring. One can easily note the difference between the magnitudes of the force or torque indicated by first arrow 740 and by second arrow 750. A second line 760 indicates the force or torque required to close the clutch. A third arrow 770 indicates the negative torque provided by the motor and friction ring to close the clutch. A fourth arrow 780 points to an average between the first line 730 and the second line 760. The fourth arrow 780 also indicates the positive torque supplied by the friction ring. Hysteresis 790 is defined as the difference in torque or force required to open the clutch and the torque or force required to close the clutch.

Other embodiments of the invention will be apparent to those skilled in the art from consideration of the specifications and practice of the invention disclosed herein. It is intended that the specification and examples be considered as exemplary only, with a true scope and spirit of the invention being indicated by the following claims.

What is claimed is:

1. In a controlled linear actuator system for actuation of a friction clutch having a housing, control fingers, and a clutch axis the actuator system is characterized by:
a screw drive generally coaxial with the clutch axis and including a collar and a screw, said screw fastened to the housing;
a friction plate arranged generally coaxial with the clutch axis and fastened to the control fingers for rotation therewith;
said collar having an associated first bearing race with a bearing race axis offset from the clutch axis;
a second bearing race in frictional engagement with said friction plate; and
a plurality of bearings associated with said first and second bearing races.

2. In a controlled linear actuator system for actuation of a friction clutch having a housing, control fingers, and a clutch axis the actuator system is characterized by:
a screw drive generally coaxial with the clutch axis and including a collar and a screw, said screw fastened to the housing;
a friction plate fastened to the control fingers for rotation therewith;
said collar having an associated first bearing race with a bearing race axis generally coaxial with the clutch axis;
said friction plate having a friction plate axis offset from the clutch axis and having an associated second bearing race in frictional engagement therewith; and
a plurality of bearings associated with said first and second bearing races.

3. The actuator system according to claim 1 wherein the screw drive has a continuously variable pitch.

4. In an actuator system for actuating a clutch, the clutch having a clutch axis, a friction disc and a pressure plate, the pressure plate having control fingers for engaging and releasing the pressure plate, the actuator system is characterized by:
a screw drive assembly, said screw drive assembly having a screw drive assembly axis;
a friction plate operatively connected to the control fingers for rotation therewith, said friction plate having a friction plate axis;
a bearing assembly operatively connected to said friction plate and to said screw drive assembly; said bearing assembly having a bearing assembly axis; and
at least one of said friction plate axis, said screw drive assembly axis, or said bearing assembly axis being offset from the clutch axis.

5. The actuator system according to claim 4, wherein said offset is constant.

6. The actuator system according to claim 4, wherein said offset is variable.

7. The actuator system according to claim 4, wherein said screw drive assembly is a ball ramp.

8. The actuator system according to claim 4, wherein said bearing assembly is intermediate to said friction plate and said screw drive assembly.

9. The actuator system according to claim 1, wherein said friction plate axis is offset from the clutch axis.

10. The actuator system according to claim 1, wherein said bearing assembly axis is offset from the clutch axis.

11. The actuator system according to claim 4, wherein said bearing assembly has a first race and a second race, said second race being in frictional engagement with said friction plate.

12. The actuator system according to claim 1, wherein said screw drive assembly axis is offset from the clutch axis.

13. The actuator system according to claim 12, wherein said bearing assembly axis is offset from the clutch axis.

14. The actuator system according to claim 4, wherein said bearing assembly includes a friction ring.

15. The actuator system according to claim 14, wherein said friction ring is made of a dry friction material.

16. The actuator system according to claim 14, wherein said friction ring is made of a PTFE-based metal-polymer material.

17. The actuator system according to claim 14, wherein said friction ring is made of a graphite material.

18. The actuator system according to claim 4, wherein said screw drive assembly includes a screw and collar, said screw having a pitch other than zero.

19. The actuator system according to claim 18, wherein said screw pitch is constant.

20. The actuator system according to claim 18, wherein said screw pitch is variable.

21. The actuator system according to claim 18, wherein said screw drive assembly includes a plurality of balls intermediate to said screw and said collar.

22. The actuator system according to claim 21, wherein said collar includes spiral grooves.

23. The actuator system according to claim 4, further including a worm gear reduction assembly operatively connected to said screw drive assembly.

24. The actuator system according to claim 23, wherein said worm gear reduction assembly includes a worm and a gear.

25. The actuator system according to claim 24, wherein said screw drive assembly includes a collar.

26. The actuator system according to claim 25, wherein said worm gear reduction assembly includes a housing that at least partially surrounds said collar.

27. The actuator system according to claim 25, wherein said gear is fastened to said collar.

28. The actuator system according to claim 25, wherein said gear is machined in said collar.

29. The actuator system according to claim 25, further comprising a shaft operatively connected to said worm.

30. The actuator system according to claim 29, further comprising a motor operatively connected to said shaft.

31. In an actuator system for actuating a clutch, the clutch being intermediate to an engine and a gearbox, the clutch having a clutch axis, a friction disc and a pressure plate, the pressure plate having control fingers for engaging and releasing the pressure plate, the actuator system is characterized by:
a friction plate operatively connected to the control fingers for rotation therewith, said friction plate having a friction plate axis;
a screw drive assembly having a screw drive assembly axis, said screw drive assembly including a flange operatively connected to the gearbox and said screw drive assembly further including a screw and a collar;
a worm gear reduction assembly having a worm and a gear, said gear operatively connected to said collar of said screw drive assembly;
a bearing assembly having a first bearing race and a second bearing race, said first bearing race operatively connected to said screw and said second bearing race operatively connected to said friction plate, said bearing assembly having a bearing assembly axis; and
at least one of said friction plate axis, said screw drive assembly axis, or said bearing assembly axis being offset from the clutch axis.

32. The actuator system according to claim 31, said offset creating a first torque biasing said screw drive assembly in a first direction.

33. The actuator system according to claim 32, said offset creating a second torque biasing said screw drive assembly in a second direction.

34. The actuator system according to claim 33, wherein said first torque is balanced with said second torque.

35. The actuator system according to claim 34, said worm gear reduction assembly mediating axial travel of said friction plate.
